(19) United States
(12) Patent Application Publication
(10) Pub. No.: US 2004/0216577 A1
(43) Pub. Date: Nov. 4, 2004

(54) Slug control tool

(76) Inventor: James J. McCrudden, Huntingdon Valley, PA (US)

Correspondence Address: Michael G. Crilly, Esquire, 104 South York Road, Hatboro, PA, 19040, US

(21) Appl. No.: 10/427,465

(22) Filed: May 1, 2003

(51) Int. Cl. B26F 1/14

(52) U.S. Cl. 83/684

(57) ABSTRACT

The present invention is a slug control tool facilitating the discard of material from a punch face in a punch-die operation. In one embodiment, the invention is comprised of an opening and a throat forming a tapered wall along the cavity of a die land. Clearance between punch and opening, as well as between punch and throat, insure contact between wall and slug some distance from the opening. In other embodiments, the tapered wall is aligned with a second tapered wall between throat and a second opening. The second tapered wall prevents contact between slug and relief The described invention is applicable to die tools including but not limited to bushings and die plates.

### NON-PROVISIONAL APPLICATION CROSS REFERENCE TO RELATED APPLICATIONS

None.

### FEDERALLY SPONSORED RESEARCH OR DEVELOPMENT

None.

### BACKGROUND OF THE INVENTION

1. Field of the Invention

The present invention generally relates to punch-die equipment. Specifically, the invention is a slug control tool that prevents pulling and/or turning of a slug produced during a punch-die related operation.

2. Description of the Related Art

Punch-die presses are widely employed to punch, cut, shear, and shape a workpiece. Punch operations in particular are problematic in that a portion of the workpiece, commonly referred to as a slug, is physically detached from the workpiece thereby requiring its discard. Failure to properly discard a slug from the punch face causes damage to workpiece and catastrophic failure of punch and die in extreme cases.

FIG. 1 shows an exemplary punch press 20 from the related arts comprised of a pressure plate 5, a die block 2, a bushing 3, and a punch 1. Components are typically composed of a metal having sufficient strength and hardness to resist deformation during punch-die operation. The punch 1 is moveable in a guided fashion within a cavity 18 through the pressure plate 5. The punch 1 shears a slug 6, comparable in shape to the punch face 12, from the workpiece 4, as represented in FIG. 3.

A workpiece 4 is typically a planar disposed sheet of material. Workpiece 4 is sandwiched between die block 2 and pressure plate 5 so as to prevent movement during a punch operation. However, the workpiece 4 is slidably disposed in a planar fashion so as to facilitate multiple or progressive operations.

FIG. 2 shows a bushing 3 known within the related arts. The bushing 3 is secured to die block 2 via mechanical means or an interference fit and aligned so that the punch 1 freely passes into a cavity 19, as represented in FIG. 3.

The described bushing 3 has a precisely machined cavity 19 through the bushing length 22. The cavity 19 is comprised of two distinct segments, namely a die land 7 and a relief 8.

As shown in FIG. 2, the die land 7 is bounded by an opening 9 at one end and a throat 10 at the other end. The width, W_{O}, of the opening 9 is dimensionally equivalent to the width, W_{T}, of the throat 10 thereby forming parallel arranged walls. The die land 7 is dimensioned so as to minimize the gap between punch 1 and bushing wall 21a when punch 1 is inserted into the die land 7. Dimensions of opening 9 and throat 10 insure mechanical locking between slug 6 and bushing wall 21a as punch 1 and slug 6 traverse the die land 7.

The relief 8 is bounded by the throat 10 at one end and relief opening 11 at the opposite end, as shown in FIG. 2. The width, W_{T}, of the throat 10 is dimensionally smaller than the width, W_{R}, of the relief opening 11. Throat 10 and relief opening 11 dimensions incline the bushing wall 21b along the relief 8 thereby allowing the slug 6 to freely fall from the bushing 3 when the slug 6 passes into the relief 8.

The described bushing 3, as well as other comparable slug control devices within the related arts, are deficient in that each promotes slug turning, see FIG. 4, and pulling, see FIG. 5.

As shown in FIG. 4, turning is the physical misalignment of slug 6 within the die land 7. Turning is caused in part by uneven contact between slug 6 and bushing wall 21a due to asymmetries about the circumference of the slug 6. Turning may also result from the formation of a vacuum within the die land 7 between punch face 12 and slug 6 during the extraction stroke of the punch 1. The described vacuum pulls and misaligns the slug 6 within the die land 7. Turning prevents the slug 6 from successfully traversing the die land 7 thereby causing the progressive accumulation of slugs 6. The result is ever increasing pressure within the die block 2 ultimately resulting in catastrophic failure of bushing 3, die block 2, and other components comprising the punch press 20.

As shown in FIG. 5, pulling is the extraction of the slug 6 from die land 7 due to adherence between slug 6 and punch face 12. Extraction is further exacerbated by the above described vacuum between punch face 12 and slug 6. Pulling frustrates slug 6 discard thereby allowing the slug 6 from one hole 14 to contact the workpiece 4 during a subsequent punch 1 engagement.

Neither grooves nor protrusions along the bushing wall as described and claimed in the related arts adequately address slug turning and pulling. Furthermore, the manufacture of precision grooves and protrusions is both difficult and costly.

What is currently required is a low-cost slug control tool that avoids the problems of the related arts and prevents both slug turning and pulling in punch-die equipment.

### SUMMARY OF THE INVENTION

An object of the present invention is to provide a low-cost slug control tool that prevents slug turning in punch-die equipment.

A further object of the present invention is to provide a low-cost slug control tool that prevents slug pulling in punch-die equipment.

The present invention is comprised of a first opening dimensionally larger than punch and slug and a throat aligned with and parallel to the first opening. The throat is dimensionally smaller than the first opening. First opening and throat form a wall that allows contact between wall and slug some distance from the first opening.

In alternate embodiments, the slug control tool is comprised of a first opening dimensionally larger than punch and slug, a second opening dimensionally larger than the slug, and a throat aligned with, disposed between, and parallel to first and second openings. The throat is dimensionally smaller than first and second openings. First opening and throat form a first wall thereby allowing contact between wall and slug some distance from the first opening. Second opening and throat form a second wall thereby preventing contact with the slug. In preferred embodiments, the first opening is smaller than second opening and the second wall is disposed at an angle of at least 0.5 degrees.

In preferred embodiments of the slug control tool, the first wall is disposed at an angle of 0 degrees, 13 minutes, 45 seconds. First opening and punch are separated by a first clearance. Throat and punch are separated by a second clearance. It is preferred to have the dimension of the first clearance twice that of the second clearance.

Two advantages are offered by the present invention. The invention is easily manufactured by low-cost, grinding and EDM methods known within the art. The invention minimizes wear along cavity walls by minimizing the amount of slug material which is deformed when contacting the walls.

### BRIEF DESCRIPTION OF THE DRAWINGS

The invention will now be described in more detail, by way of example only, with reference to the accompanying drawings, in which:

FIG. 1 is a section view of an exemplary punch-die arrangement known within the art.

FIG. 2 is an enlarged section view of bushing showing cavity shape and dimensions.

FIG. 3 is a section view of punch-die arrangement after slug is detached from workpiece.

FIG. 4 is a section view of punch-die arrangement after punch is retracted and slug turned within bushing.

FIG. 5 is a section view of punch-die arrangement after punch is retracted with slug adhered to punch face and before subsequent punch operation.

FIG. 6 is an enlarged section view of an embodiment of the present invention showing mutually opposed tapered walls along cavity having die land and relief.

FIG. 7 is an enlarged section view as shown in FIG. 6 with slug and punch within die land.

FIG. 8 is an enlarged section view of punch and bushing from FIG. 7 showing clearance between punch and cavity.

FIG. 9 is an enlarged section view of an alternate embodiment of the present invention showing tapered wall along cavity comprising die land and shaped relief.

FIG. 10 is an enlarged section view of an alternate embodiment of the present invention comprised of tapered die land through a first plate contacting a second plate having a shaped relief.

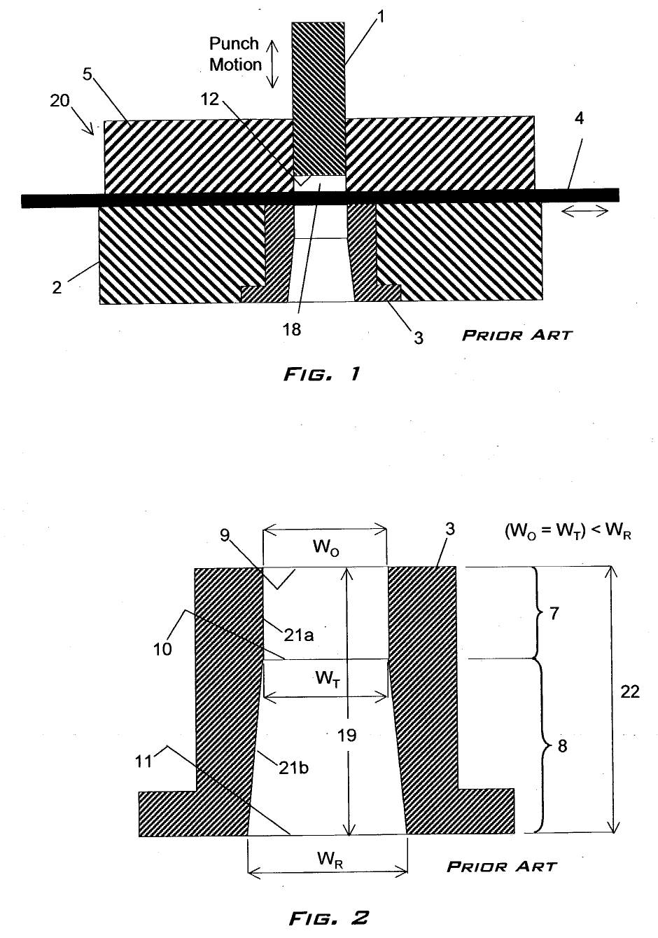

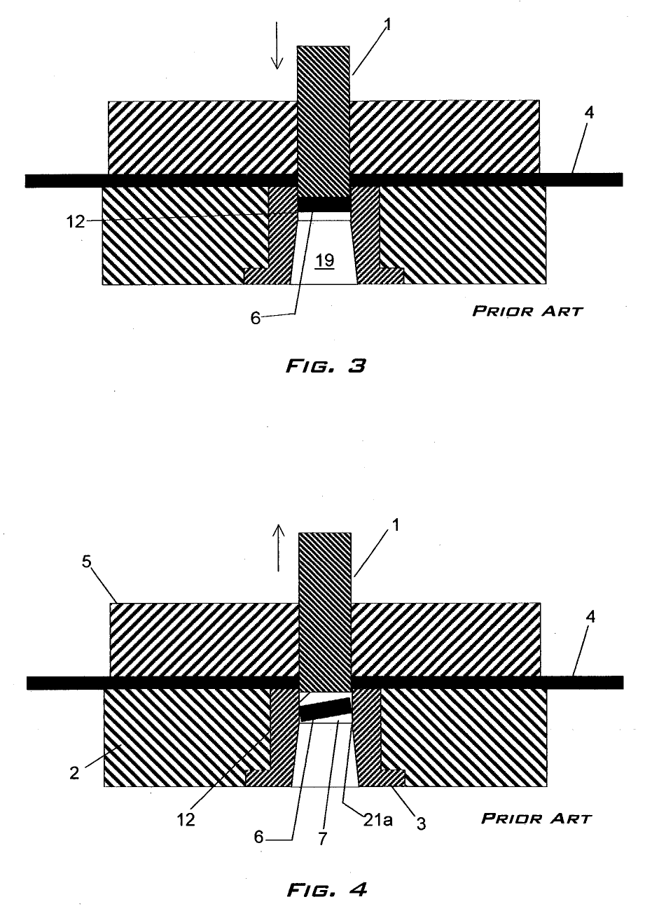

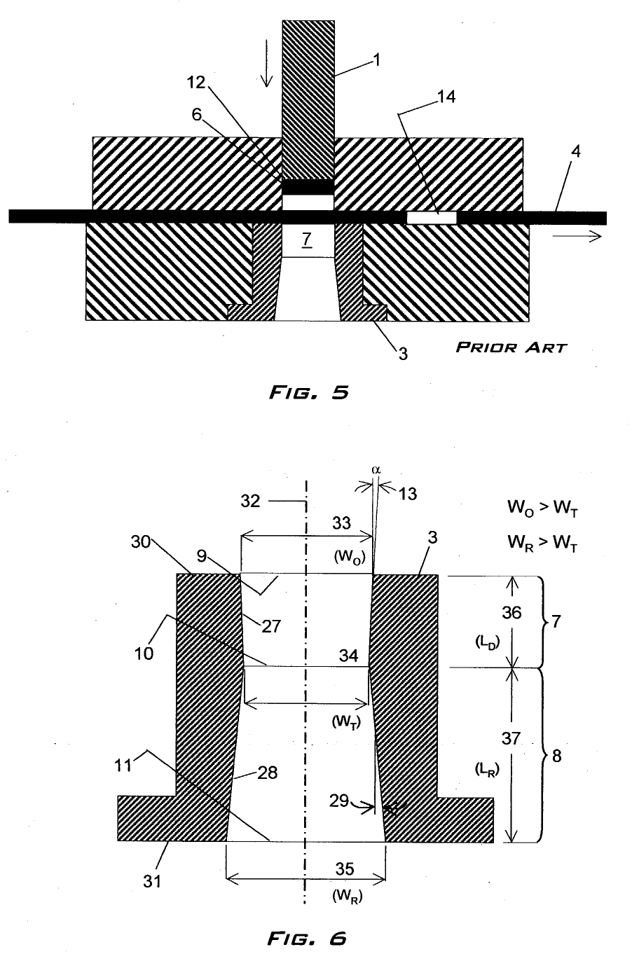

### REFERENCE NUMERALS

1 Punch

2 Die block

3 Bushing

4 Workpiece

5 Pressure plate

6 Slug

7 Die land

8 Relief

9 Opening

10 Throat

11 Relief opening

12 Punch face

13 Wall angle

14 Hole

15 First clearance

16 Punch path

17 Second clearance

18 Cavity

19 Cavity

20 Punch press

21 Bushing wall

22 Bushing length

23 Inclined surface

24 Vertical surface

25 Upper die plate

26 Lower die plate

27 First wall

28 Second wall

29 Wall angle

30 Top surface

31 Bottom Surface

32 Central Axis

33 Opening width

34 Throat width

35 Relief opening width

36 Die land depth

37 Relief depth

38 Punch side wall

39 Layered die block

### DESCRIPTION OF THE INVENTION

FIGS. 6 through 10 show and describe the present invention. The described invention is applicable to a variety of punch shapes and sizes. While the present invention is specifically described with bushings and plates, other die tool applications are equally appropriate.

Referring now to FIG. 6, an embodiment of the present invention is shown comprised of a bushing 3 having a die land 7 axially aligned and communicating with a relief 8.

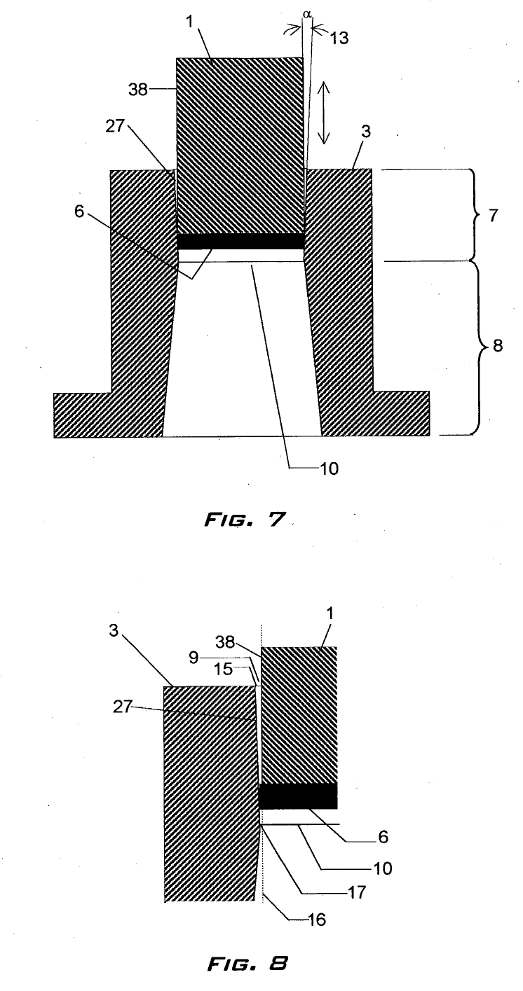

The die land 7 is bounded by an opening 9 and a throat 10. The opening 9 is located along the top surface 30 of the bushing 3 and symmetrically positioned about a central axis 32. The throat 10 is likewise symmetrically located about the central axis 32 and parallel to the opening 9. The distance between opening 9 and throat 10 defines the die land depth 36 (L_{D}) and is application dependent. The opening width 33 (W_{O}) is greater than the throat width 34 (W_{T}) thereby forming an inclined or tapered profile along the first wall 27. The described first wall 27 may consist of a circular structure, wherein opening width 33 and throat width 34 are diametrical measurements, or a pair of geometrically symmetrical surfaces, wherein opening width 33 and throat width 34 are lineal measurements. Profile and dimensions of the die land 7 should be sufficient so as to allow slug 6 to contact the first wall 27 in a symmetrical fashion prior to reaching the throat 10, as represented in FIG. 7.

Referring again to FIG. 6, the relief 8 is bounded by the throat 10 and a relief opening 11. The relief opening 11 is located along the bottom surface 31 of the bushing 3 and symmetrically positioned about the central axis 32. The distance between throat 10 and relief opening 11 defines the relief depth 37 (L_{R}) and is application dependent. The relief opening width 35 (W_{R}) is greater than the throat width 34. In preferred embodiments, the opening 9 is dimensionally smaller than relief opening 11. The described second wall 28 may consist of a circular structure, wherein relief opening width 35 and throat width 34 are diametrical measurements, or a pair of geometrically symmetrical surfaces, wherein relief opening width 35 and throat width 34 are lineal measurements.

The second wall 28 within the relief 8 may include a variety of shapes including linear segments, curved segments, and combinations thereof For example, in preferred embodiments throat 10 and relief opening 11 form an inclined or tapered profile along the second wall 28 about the relief 8, as shown in FIG. 6. While a variety of wall angles 29 are applicable, preferred embodiments have a wall angle 29 of at least 0.5 degrees.

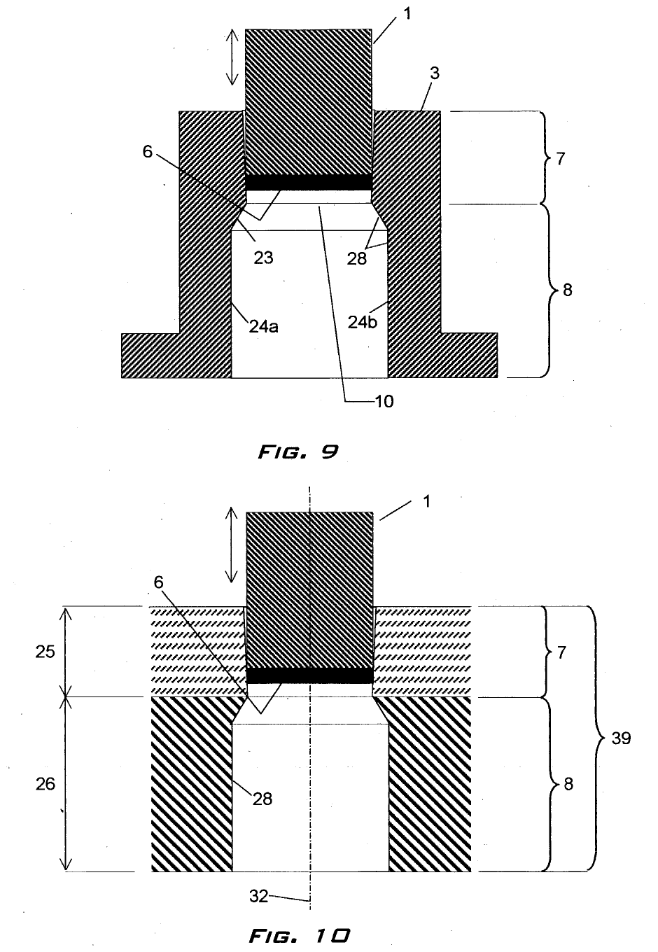

Referring now to FIG. 9, an alternate embodiment of the present invention is shown with a second wall 28 having an inclined surface 23 immediately disposed and aligned with the die land 7 thereafter having a pair of symmetrically arranged and parallel vertical surfaces 24a, 24b. Profile and dimensions along the relief 8 should be sufficient so as to allow a slug 6 to freely traverse the relief 8 after having passed through the throat 10.

Referring again to FIG. 7, a die land 7 comprising a linearly inclined first wall 27 was disposed at a wall angle 13 (α) with respect to the punch side wall 38. Referring now to FIG. 8, the described angular displacement between punch side wall 38 and first wall 27 provides a dimensionally sufficient first clearance 15 between punch path 16 and opening 9 and a dimensionally sufficient second clearance 17 between punch path 16 and throat 10 so as to prevent contact between punch 1 and bushing 3. In preferred embodiments, a wall angle 13 having a value of 0 degrees, 13 minutes, and 45 seconds was sufficient to prevent slug turning and pulling. In yet other embodiments, it was desired to have a first clearance 15 twice that of the second clearance 17. For example, a first clearance 15 of 0.001 inches and a second clearance 17 of 0.0005 inches over a land depth 36 of 0.125 inches adequately prevented slug turning and pulling for punch operations involving metal workpieces 4.

Referring now to FIG. 10, a layered die block 39 is shown comprised of an upper die plate 25 and a lower die plate 26. In this exemplary embodiment, upper die plate 25 is a planar shaped member having one or more die lands 7 and lower die plate 26 is a separately disposed planar shaped member having one or more reliefs 8. Upper die plate 25 and lower die plate 26 are aligned and contacting so that die land 7 and relief 8 are aligned and communicating about a mutually arranged central axis 32.

Precisely machined die land 7 and relief 8 are fabricated via techniques understood in the art. For example, die land 7 and relief 8 may be precision manufactured via one or more grinding operations. Furthermore, die land 7 and relief 8 may be cut into plate stock via wire EDM methods.

The description above indicates that a great degree of flexibility is offered in terms of the present invention. Although the present invention has been described in considerable detail with reference to certain preferred versions thereof, other versions are possible. Therefore, the spirit and scope of the appended claims should not be limited to the description of the preferred versions contained herein.

What is claimed is:

1. A slug control tool comprising:
(a) a first opening dimensionally larger than a punch and a slug; and
(b) a throat aligned with and parallel to said first opening, said throat dimensionally smaller than said first opening, said first opening and said throat forming a wall thereby allowing contact between said wall and said slug some distance from said first opening.

2. The slug control tool in claim 1, wherein said wall is disposed at an angle of 0 degrees, 13 minutes, 45 seconds.

3. The slug control tool in claim 1, wherein said first opening and said punch are separated by a first clearance, said throat and said punch are separated by a second clearance, said first clearance twice said second clearance.

4. The slug control tool in claim 3, wherein said first clearance is 0.001 inches, said first opening and said throat are separated by a distance of 0.125 inches.

5. A slug control tool comprising:
(a) a first opening dimensionally larger than a punch and a slug;
(b) a second opening dimensionally larger than said slug; and
(c) a throat aligned with, disposed between, and parallel to said first opening and said second opening, said throat dimensionally smaller than said first opening and said second opening, said first opening and said throat forming a first wall thereby allowing contact between said first wall and said slug some distance from said first opening, said second opening and said throat forming a second wall thereby preventing contact with said slug.

6. The slug control tool in claim 5, wherein said first opening is small than said second opening.

7. The slug control tool in claim 5, wherein said first wall is disposed at an angle of 0 degrees, 13 minutes, 45 seconds.

8. The slug control tool in claim 5, wherein said first opening and said punch are separated by a first clearance, said throat and said punch are separated by a second clearance, said first clearance twice said second clearance.

9. The slug control tool in claim 8, wherein said first clearance is 0.001 inches, said first opening and said throat are separated by a distance of 0.125 inches.

10. The slug control tool in claim 1, wherein said second wall is disposed at an angle of at least 0.5 degrees.
